(19) United States
(12) Patent Application Publication
(10) Pub. No.: US 2012/0085326 A1
(43) Pub. Date: Apr. 12, 2012

(54) METHOD AND APPARATUS FOR CONVERTING DIESEL ENGINES TO BLENDED GASEOUS AND DIESEL FUEL ENGINES

(76) Inventors: Feng Mo, Lewisville, TX (US); James A. Stroup, Farmers Branch, TX (US); Ridha Berriche, Dallas, TX (US); Maurice Schwegman, Terra Verde, TX (US)

(21) Appl. No.: 13/269,623

(22) Filed: Oct. 10, 2011

Related U.S. Application Data
(60) Provisional application No. 61/391,645, filed on Oct. 10, 2010.

(51) Int. Cl. F02M 21/00

(52) U.S. Cl. 123/526

(57) ABSTRACT

The invention presents a method of converting a diesel fueled engine to a blended-fuel engine capable of operating on blended gaseous fuel and diesel fuel, where the diesel fueled engine has a plurality of cylinders, a plurality of diesel fuel injectors for injecting diesel fuel into the cylinders, and an Engine Control Unit (ECU) for controlling at least the operation of the diesel injectors by sending diesel fuel injector control signals to the diesel fuel injectors.

### CROSS-REFERENCE TO RELATED APPLICATION

This application is a U.S. Non-Provisional application of and claims priority to U.S. Provisional Patent Application Ser. No. 61/391,645, filed Oct. 10, 2010, to Feng Mo, entitled “A Device to Convert a Conventional Diesel Engine to Run on Blended Liquified Natural Gas (LNG)/Compressed Natural Gas (CNG) and Diesel” which application is incorporated herein by reference for all purposes.

### BACKGROUND

### Technical Field

The inventions generally relate to converting diesel fueled engines to blended fuel engines. More particularly, the invention is directed to converting and operating diesel fueled engines to blended gaseous fuel and diesel fuel engines.

### Background

Most of the long haul trucks nowadays run on diesel fuel. Converting these trucks to run on a gaseous fuel has compelling economic and environmental benefits. In practice, the lower energy content of gaseous fuels compared to diesel fuel presents a problem. The engines run on gaseous fuel do not have adequate torque or horsepower to pull a heavy load from still or up a grade at reasonable speed or acceleration.

The invention presents a method of converting a conventional diesel fuel engine to run on blended gaseous fuel and diesel fuel. The invention solves the problems with adequate or desired torque and horsepower commonly associated with gaseous fuel engines by continuously adjusting the ratio of the diesel-to-gaseous fuel in the blended fuel delivered to the engine. When high torque or high horsepower is required, the ratio of diesel-to-gaseous fuel is relatively high, so that the engine runs on a higher proportion of diesel fuel or even completely on diesel fuel. When the torque or horsepower demand is low, such as cruising on highway, the ratio of diesel-to-gaseous fuel is relatively low, so that the engine runs on a higher proportion of gaseous fuel.

### SUMMARY OF THE INVENTION

The invention includes a method of converting a diesel fueled engine to a blended-fuel engine capable of operating on blended gaseous fuel and diesel fuel, where the diesel fueled engine has a plurality of cylinders, a plurality of diesel fuel injectors for injecting diesel fuel into the cylinders, and an Engine Control Unit (ECU) for controlling at least the operation of the diesel injectors by sending diesel fuel injector control signals to the diesel fuel injectors. In a preferred embodiment, the method includes positioning a modified intake manifold adjacent the plurality of cylinders, the modified intake manifold for feeding fuel to the plurality of cylinders; positioning a plurality of diesel fuel injectors in the modified intake manifold, the plurality of diesel fuel injectors for injecting diesel fuel into the plurality of cylinders; positioning a plurality of gaseous fuel injectors in the modified intake manifold, the plurality of gaseous fuel injectors for injecting gaseous fuel into the plurality of cylinders; and positioning a Blended Fuel Injector Control Unit (BFICU) between the Engine Control Unit and the plurality of diesel and gaseous fuel injectors, the Blended Fuel Injector Control Unit for receiving Engine Control Unit diesel injector control signals from the Engine Control Unit and for sending BFICU control signals to the diesel fuel injectors and gaseous fuel injectors.

The method can also include additional steps, such as installing a gaseous fuel tank in fluid communication with the gaseous fuel injectors, and installing a gaseous fuel gauge for indicating the gaseous fuel level in the gaseous fuel tank.

The method preferably includes installing a Blended Fuel Injector Control Unit which has a plurality of diesel fuel injector control driver outputs and a plurality of gaseous fuel injector driver outputs, and further connecting the plurality of diesel fuel injectors to the plurality of diesel fuel injector driver outputs and connecting the plurality of gaseous fuel injectors to the plurality of gaseous fuel injector driver outputs. The Blended Fuel Injector Control Unit calculates a desired gaseous fuel injection timing and duration based, at least in part, on received Engine Control Unit diesel injector control signals. The BFICU preferably calculates a desired diesel fuel injection timing and duration based, at least in part, on received Engine Control Unit diesel injector control signals. The BFIC calculates a desired fuel proportion of diesel fuel and gaseous fuel to be injected, where the combined energy per injection of the proportioned diesel and gaseous fuels is approximately equal to the designed engine energy per injection. The BFICU, in operation, varies the proportion of diesel fuel and gaseous fuel injected into the cylinders, from one injection cycle to another injection cycle, by varying the duration of diesel injection and the duration of gaseous fuel injection. In one embodiment, the BFICU is operable to vary the proportion of diesel fuel and gaseous fuel injected into the cylinders, from one injection cycle to another injection cycle, by varying the pressure of the diesel fuel entering the diesel fuel injector.

The method may also include calibrating the Blended Fuel Injector Control Unit by operating the engine at a selected initial speed, measuring the diesel fuel intake at that speed, then utilizing the Blended Fuel Injector Control Unit to inject a proportion of diesel fuel and gaseous fuel to the cylinders, then modifying the proportion such that the engine returns to approximately the initial speed.

The invention also includes apparatus for operating an engine on blended diesel and gaseous fuel, a blended fuel engine, methods of conversion from a diesel engine to a blended fuel engine and methods of operation of such an engine.

The features and advantages of the present invention will be apparent to those skilled in the art. While numerous changes may be made by those skilled in the art, such changes are within the spirit of the invention.

### BRIEF DESCRIPTION OF THE DRAWING

The accompanying drawing is incorporated into the specification to help illustrate examples according to the presently most-preferred embodiment of the invention.

FIG. 1 is a fuel conversion system according to one embodiment of the invention;

FIG. 2 is a plan diagram of a diesel engine having a blended fuel conversion system installed according to an embodiment of the invention;

FIG. 3 is a graphical representation of injector control signals according to an embodiment of the invention compared to similar signals in an engine without the conversion system;

FIG. 4 is a plan diagram of a HEUI System type engine having a conversion system installed according to one embodiment of the invention;

FIG. 5 is a circuit diagram corresponding to the system of FIG. 4;

FIG. 6 is a graphical representation of injector timing and duration according to an embodiment of the invention; and

FIG. 7 is a circuit diagram for a common rail type engine having the conversion system installed according to an embodiment of the invention.

### DETAILED DESCRIPTION OF PRESENTLY PREFERRED EMBODIMENTS

As used herein, “gaseous fuel” includes methane, Liquified Natural Gas (LNG), Compressed Natural gas (CNG), natural gas, hydrogen, butane, and other fuels which, at the time of injection into the engine cylinders, are in gaseous form. Note that some fuels may be stored in liquid form but are in gaseous form upon entering the engine cylinders.

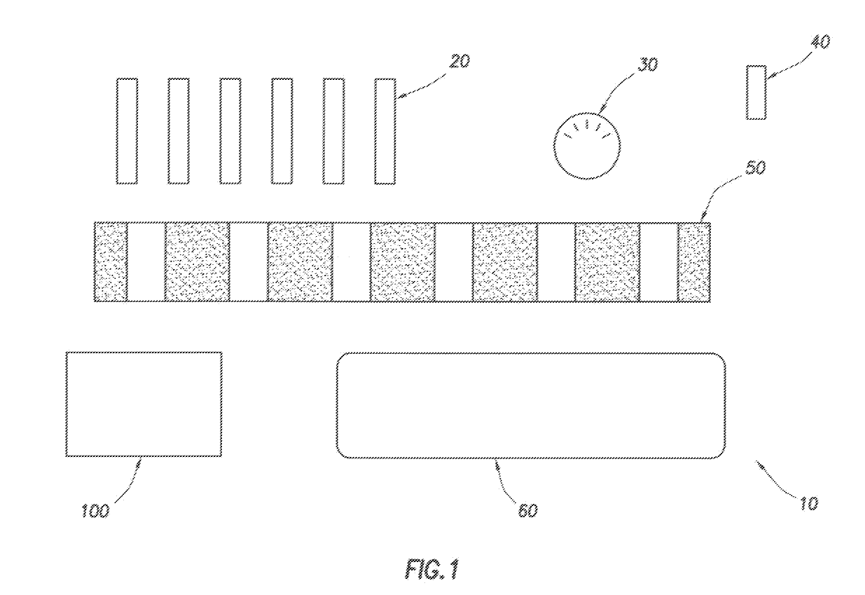

FIG. 1 shows an exemplary embodiment of a blended fuel system 10 having a plurality of gaseous fuel injectors 20, a gaseous fuel gage 30, an LED display 40 for indicating proper operation of the system, a modified intake manifold 50, a gaseous fuel tank 60, and a blended fuel injector control unit (BFICU) 100. It is to be understood that the modified intake manifold 50 is different from the original equipment manufacturer's (OEM) manifold to allow for the functionality as explained herein. The term “modified” does not necessarily imply that the OEM manifold is itself modified; in fact, it is, in a preferred embodiment, replaced with a separate manifold meeting the requirements herein.

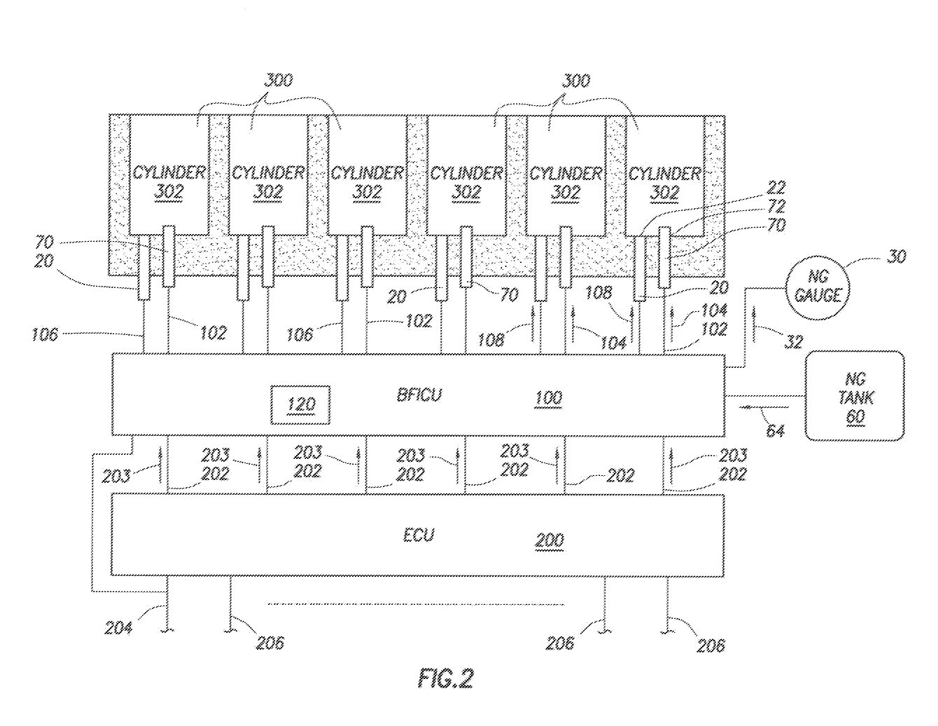

The system 10 is shown in FIG. 2 installed in an existing diesel engine. The BFICU 100 is installed between the existing diesel engine control unit (ECU) 200 and the diesel fuel injectors. The existing ECU 200 has diesel injector control lines 202 for controlling the diesel injectors 70, namely, controlling the timing and duration of the injections through the diesel injectors. The ECU 200 sends diesel injector driver control signals 203 designed to operate and control the diesel injectors 70. The ECU 200 typically also has various input signals from various sensors, such as exhaust temperature signals 204, intake air pressure, crank position sensor, crank speed sensor, diesel fuel pressure sensor, etc. The ECU 200 also typically contains a microprocessor or other device for various calculations and to process incoming signals and drive output signals. The ECU 200 typically contains, calculates and/or manipulates data related to at least some of the designed energy per injection for the diesel engine, injection timing, injection duration, engine speed, air pressure, fuel energy density, injection rates, fuel volume or level, injection pressure relief (IPR) valve operation, Injector Control Pressure (ICP) data, and other sensed parameters 206. Generally, all the sensed parameters which send signals to the ECU 200 are referred to herein as sensed parameters 206. The sensed parameters 206 may vary from engine type, model and make and are not expected to be identical in all cases. The ECU 200 will also derive or calculate values based on the sensed and stored data. The ECU is not described herein in detail and is well understood by those of skill in the art.

The BFICU 100 is operably connected to the ECU 200 to receive signals, especially the ECU diesel injector drive signals 203 through diesel injector control lines 202 or similar. The BFICU 100 may also receive additional signals and data from the ECU through the same or additional connections or lines. The BFICU can also receive additional data and signals directly from other sensors or devices, such as directly from the exhaust manifold temperature signal 204. In the preferred embodiment shown, the exhaust manifold temperature signal 204 is directed to both the ECU 200 and the BFICU 100 directly. Other arrangements will be understood by those of skill in the art. The BFICU 100 is also preferably connected to a volume or level sensor 62 which send gaseous fuel volume signals 64 from the gaseous fuel tank 60.

The BFICU 100 has a plurality of BFICU diesel injector control lines 102 for sending BFICU diesel injector control signals 104 to the plurality of diesel fuel injectors 70. Similarly, the BFICU 100 has a plurality of BFICU gaseous injector control lines 106 for sending BFICU gaseous injector control signals 108 to the plurality of gaseous fuel injectors 20. The BFICU 100 can also output additional signals and operate additional devices as those of skill in the art will understand. For example, the BFICU 100 is shown connected to send gaseous fuel gauge signals 32 to the gaseous fuel gauge 30. The gauge 30 is preferably mounted in the vehicle, such as on the dashboard, for reading by the driver. Similarly, the BFICU can send LED signals to operate the LED display 40 to indicate information to the driver. The BFICU 100 also typically contains a microprocessor 120 or other device for various calculations and to process incoming signals and drive output signals. The BFICU 200 typically contains, calculates and/or manipulates data related to at least some of the designed energy per injection for the diesel engine, injection timing, injection duration, engine speed, air pressure, fuel energy density, injection rates, fuel volume or level, injection pressure relief (IPR) valve operation, Injector Control Pressure (ICP) data, and other sensed parameters.

The modified intake manifold 50 is installed adjacent the existing engine cylinders 300 and functions, as the original intake manifold, to control intake of fuel into the cylinders. However, the modified intake manifold 50 is designed to allow and control intake of both diesel and gaseous fuel into the engine. The gaseous fuel injectors 20 are installed in the modified intake manifold 50 in gaseous fuel injector ports 22. The diesel fuel injectors 70 are installed in the modified intake manifold 50 in diesel fuel injector ports 72. In a preferred embodiment, the gaseous fuel is injected sequentially into an intake valve port (SPI) 22 while the diesel fuel is injected directly into the combustion chamber 302 (TBI) and blended in the cylinder combustion chamber.

The BFICU 100 monitors the ECU diesel injector control signals 203 from the ECU. The BFICU typically determines parameters such as engine speed (rpm), the timing of the diesel fuel injection, duration of the diesel fuel injection, and the desired energy injection rate. The BFICU calculates the ratio or proportion of the diesel-to-gaseous fuel blend based upon one or more of the engine speed, injection timing, injection duration, known OEM designed energy injection rate, or other parameters. The BFICU 100 then determines the gaseous fuel injection timing and duration, typically from the diesel injection timing signal and the calculated engine speed. The BFICU controls the gaseous fuel volume delivered to the cylinder combustion chamber. The BFICU sends BFICU gaseous fuel injector control signals 108 to the gaseous fuel injectors 20, thereby operating the gaseous fuel injectors, opening and closing the injectors to fuel flow at the appropriate times, to deliver the proper amount of gaseous fuel to the cylinder combustion chamber at the proper time. In a preferred embodiment, the gaseous fuel injection is performed into the intake valve port 22 and then into the combustion chamber 302. Similarly, the BFICU sends BFICU diesel fuel injector control signals 104 to the diesel injectors 70, thereby operating the diesel fuel injectors, opening and closing the injectors to fuel flow at the appropriate times, to deliver the proper amount of diesel fuel to the cylinder combustion chamber at the proper time. In a preferred embodiment, the diesel injection is performed directly into the combustion chamber 302.

The BFICU thus proportions the OEM designed energy per injection between the gaseous fuel and the diesel fuel resulting in a seamless transition from diesel to blended fuel without excessive or reduced energy introduced to the diesel engine. Since the total energy in each cylinder is within the OEM design limits, no sensed engine parameters are adversely impacted.

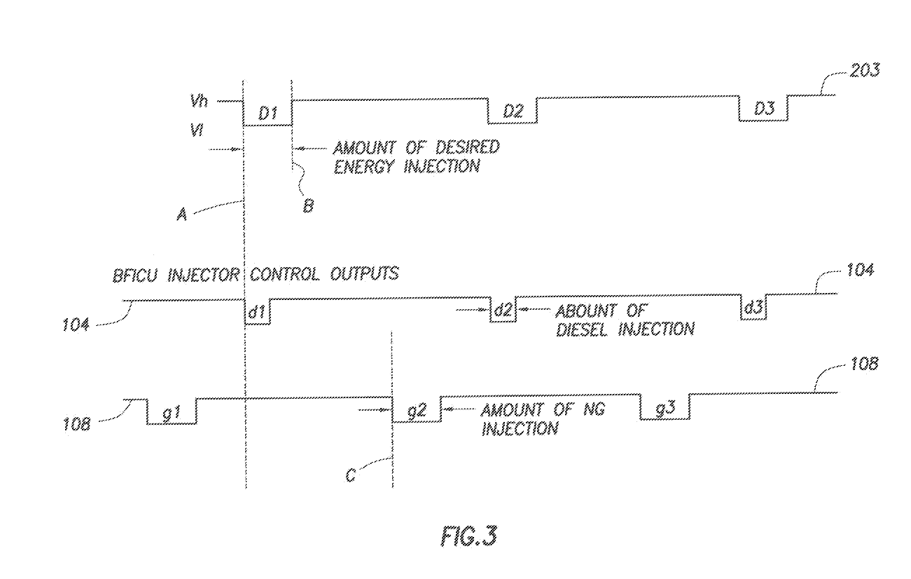

FIG. 3 is a timing diagram for an exemplary 50-50 diesel-gaseous fuel blend. FIG. 3 shows the ECU injector control outputs or signals 203 and indicates the amount of desired energy injection for a diesel fuel only engine. The amount of energy injection 400 is achieved by a diesel fuel injection of a duration, D1, which allows for injection of a corresponding volume of diesel fuel. The start of the diesel fuel injection is indicated by the dashed line A; the end of the diesel injection is indicated by the dashed line B. The diesel fuel injection is then repeated at D2 and D3, indicating injection cycles or events. Obviously, the diesel injection duration may be varied by the ECU depending on engine conditions such as engine speed, torque and horsepower requirements, etc.

Also shown in FIG. 3 are the BFICU diesel injector control outputs or signals 104 and gaseous fuel injector control signals 108. Here, the equivalent desired amount of energy injection is achieved by a shorter duration diesel fuel injection and a gaseous fuel injection. The diesel fuel injection dl begins at the same time, indicated by dashed line A, but is of a shorter duration, delivering a smaller volume of diesel fuel. The smaller amount of diesel fuel delivers a correspondingly smaller energy amount. The “missing” energy amount is provided by substituted gaseous fuel. Typically the gaseous fuel is delivered prior to the injection of the diesel fuel in any given injection cycle. Thus, gaseous fuel injection g1 is injected into the cylinder prior to diesel fuel injection d1. For the next cycle, the gaseous fuel injection g2 starts at a time indicated by dashed line C. The gaseous injection is repeated at g3, etc., for each injection cycle. The gaseous and diesel fuels blend in the combustion chamber. The gaseous fuel injection results in injection of a gaseous fuel volume with a corresponding energy amount, although at a different energy density than the diesel fuel. The combined diesel and gaseous fuel energy amounts in injections d1 and g1 sum to equal an energy amount equivalent to that of the single diesel injection D1. Thus, gaseous fuel substitutes for a portion of the diesel fuel normally used. The substitution can best be thought of as energy substitution, since the energy amount in the diesel is what is being replaced, but of course the energy amount has a corresponding fuel volume.

The BFICU controls these injections, their timing, and duration. In a preferred embodiment, for any given cycle, the gaseous fuel is injected before the diesel fuel. For example, the gaseous fuel can be injected at approximately 360 degrees before top dead center (TDC) while the diesel injection occurs at approximately 10 degrees before TDC. Further, in a preferred embodiment, the durations of the diesel and gaseous fuel injections do not overlap.

When the desired energy injection rate is high and the engine speed is low (a high torque situation), or when the designed energy injection rate is high and the engine speed is high (a high horsepower situation), the BFICU sets the diesel-to-gaseous fuel ratio or proportion relatively higher so that the engine runs on a relatively higher proportion of diesel. Otherwise, the BFICU progressively increases the proportion of the gaseous fuel and decreases the diesel energy injection in each sequential injection cycle as the total desired energy injection is throttled lower and engine speed is moderate. FIG. 3 shows exemplary injector control signals for a 50-50 fuel blend.

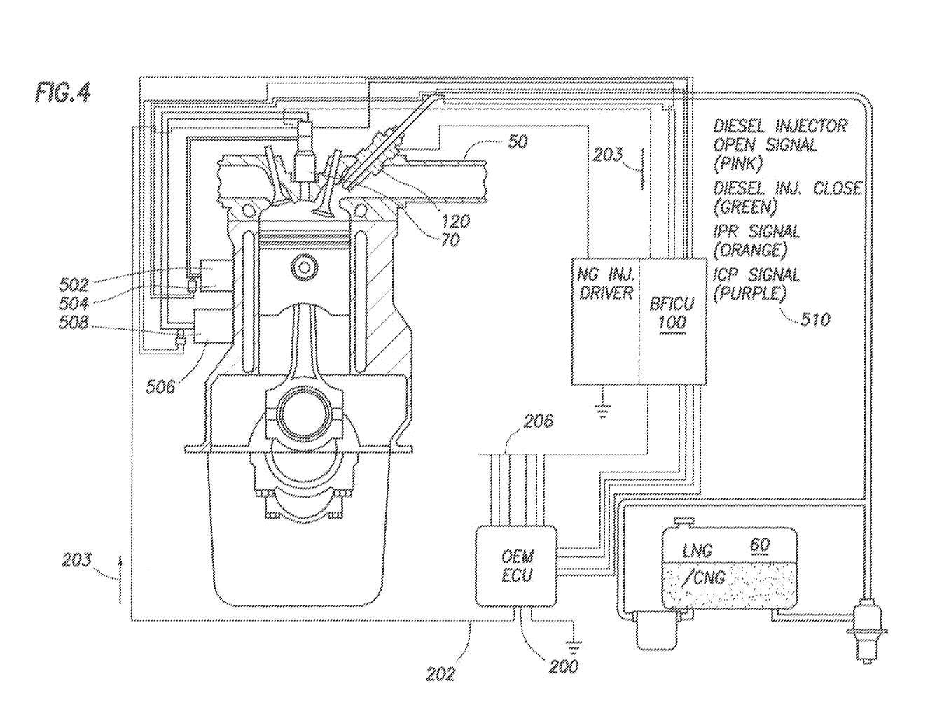

FIG. 4 shows an embodiment of the current system for an Hydraulic activated Electronic controlled Unit Injection (HEUI) system used in diesel engines 500. The HEUI system is used in commercially available diesel engines such as Caterpillar (trademark) diesel engines and truck engine models such as the International (trademark) DT466. The HEUI system controls the diesel fuel injection rate through two parameters: the duration of each fuel injection cycle and the pressure of the fuel entering the fuel injector. The pressurization of the diesel fuel is achieved by a diesel HP pump 502 and regulated through an Injection Pressure Relief (IPR) valve 504 and monitored through an Injector Control Pressure (ICP) sensor 506 in a hydraulic pump 508 in a closed loop control scheme. The HEUI diesel fuel injectors 70 have two electric coils, one to start and one to stop the diesel fuel injection. To start diesel fuel injection for a specific engine cylinder, the open coil for that cylinder's fuel injector is energized for a predetermined duration of time as computed by the engine manufacturer's Engine Control Unit 200. Energizing the open coil opens the hydraulic port at the top of the diesel injector 70. The high-pressure hydraulic fluid enters the diesel injector and pressurizes the diesel fuel in the injector and forces open the diesel injector port. This starts the diesel fuel injection. To stop the diesel fuel injection, the injector's close coil is energized which closes the hydraulic port of the diesel fuel injector. With the fuel pressure removed, the diesel injector port closes, ending the diesel fuel injection.

The BFICU 100 modifies the diesel fuel delivery volume, and corresponding energy amount, by controlling the pressure of the hydraulic fluid used in diesel injection function while simultaneously modifying the time lag between the activation of the diesel injector's open coil and the activation of the injector's close coil. In order to make the adjustment of the hydraulic pressure transparent to the engine's ECU 200, the BFICU 100 intercepts and modifies the ICP sensor signal 510 before sending a modified ICP sensor signal 512 to the ECU.

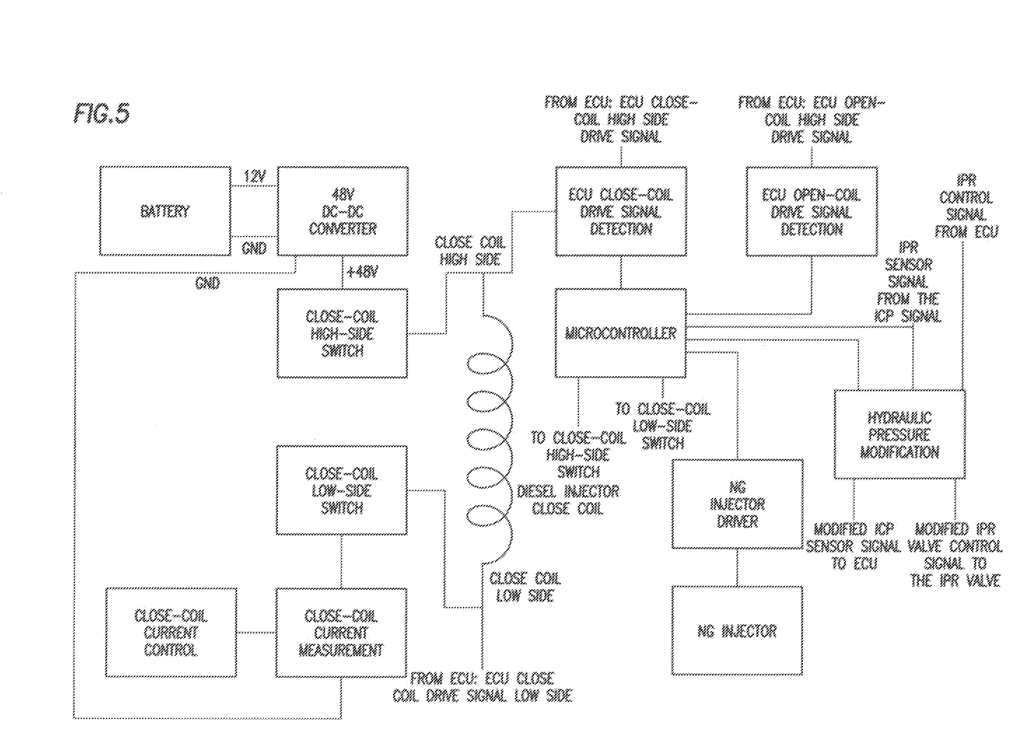

FIG. 5 shows a circuit diagram for a blended fuel injection system 10 for a HEUI-based diesel fuelled engine 500. For simplicity, circuits for only one cylinder are shown.

The engine ECU injector open-coil drive signal detection and the engine ECU close-coil drive signal modules of the BFICU monitor the injector drive signals from the ECU to detect the start and the end of the open-coil pulses as well as the close-coil pulses. This open and close data is sent to the BFICU microcontroller to extract the timing and the duration, or volume, information of each diesel injection. The BFICU microcontroller also monitors the hydraulic pressure readings from the ICP sensor. Based upon these data, the BFICU microcontroller determines the percentage volume of diesel substitution and modifies the hydraulic pressure and the injection duration accordingly. The BFICU microcontroller modifies injection hydraulic pressure by intercepting and modifying the IPR valve control signal. In order to make the hydraulic pressure modification transparent to the engine ECU, the BFICU microcontroller intercepts and scales the ICP sensor readings in reverse proportion to the IPR control signal modification. The BFICU micro controller then sends the modified ICP readings to the engine ECU.

The BFICU microcontroller modifies the diesel injection timing by energizing the close coil of the specific cylinder injector prior to the engine ECU to shorten the diesel fuel injection duration. In order to generate this early close coil pulse, a 48V power supply and a 20 AMP constant current close loop control circuit are used to generate the 20 AMP close coil pulse. In FIG. 5, the close coil current measurement module, the close coil current control module, and the close coil high side switch module work together to perform the current servo control function.

With the reduction of the injector hydraulic pressure and the shortening of the diesel injection duration, the diesel fuel delivery rate to the engine is reduced. The reduced diesel energy delivery rate is compensated by gaseous fuel energy delivered to the engine that is equivalent in energy content to the diesel fuel energy removed.

When the BFICU close coil drive signal is active, the microcontroller monitors the engine ECU close coil drive signal to detect the start of the ECU close coil pulse. Once the close coil signal from the engine ECU is detected, the BFICU microcontroller shuts down the BFICU close coil drive signal and allows the ECU control signal to take over. The ECU close coil drive signal detection module provides a low impedance connection of the ECU close coil high side drive signal to the high side of the diesel injector close coil. This means the ECU close coil drive signal always goes through to the close coil of the specific diesel injector. This design feature allows the engine ECU On Board Diagnostic (OBD) function to monitor and diagnose the injector operation with or without the BFICU installed, making the insertion of the BFICU transparent to the engine ECU and without disturbing any other OBD monitored parameters.

The IPR valve 504 is controlled through a pulse-width-modulated (PWM) signal. To increase the hydraulic pressure of the diesel fuel injection, the duty cycle of the valve is increased. To decrease the pressure, the duty cycle of the valve is decreased. The diesel fuel delivery rate is directly proportional to the hydraulic pressure. The BFICU 100 calculates the target duty cycle based upon the duty cycle of the IPR control signal sent from the engine ECU and the proportion of the diesel fuel to be substituted by the gaseous fuel as discussed previously through the injection hydraulic pressure modification:

duty_cycle_{BFICU}=(1−fₚ)*duty_cycle_{ECU} (1)

where fₚ is the proportion of the diesel fuel substituted by the hydraulic pressure modification. The BFICU duty cycle modification is subject to the requirement that the hydraulic pressure must be above a minimal value as fixed by the OEM engine design for the diesel fuel injection to be initiated. The BFICU continuously monitors the duty cycle of the engine ECU IPR control signal and adjusts the duty cycle of the IPR valve as calculated by the BFICU and sends to the IPR valve a modified IPR control signal according to the formula shown (1) above.

In order to make the gaseous/diesel fuel energy substitution transparent to the engine ECU, whenever the duty cycle of the IPR valve control signal is modified by the BFICU, the ICP sensor signal is likewise modified inverse proportionally so that the engine ECU does not see a injection hydraulic pressure drop:

icp_{BFICU}=icp/(1−fₚ) (2)

where icp_{BFICU} is the modified ICP sensor signal delivered by the BFICU to the ECU. Where icp is the original ICP sensor value.

The diesel fuel injection time is modified by energizing the close coil of the diesel fuel injector in advance of the close-coil-energizing signal by the engine ECU. The amount of the diesel injection time reduction formula is

t_{red}=(t_{ecu}=tₘᵢₙ) (3)

where t_{ecu} is the unmodified diesel injection time from the engine ECU. tₘᵢₙ is the minimal diesel injection time after the reduction, which is set to 800 microseconds. When t_{ecu} is less than tₘᵢₙ, no diesel injection duration modification is performed and the engine operates on 100 percent diesel fuel.

The total amount of diesel substitution in percentage is

r_{sub}=100−(100−r_{sub,p})*(100−r_{sub,t})/100 (4)

where

r_{sub,p} is the diesel substitution through the hydraulic pressure modification, r_{sub,t} is the diesel substitution through the diesel injection time modification.

r_{sub,p}=100*fₚ (5)

r_{sub,t}=100*t_{red}/t_{ecu} (6)

For example: if the hydraulic pressure is scaled down from 2800 psi to 1300 psi, and the diesel injection time is reduced from 1300 microseconds to 800 microseconds, then

fₚ=1−1300/2800=0.54

r_{sub,p}=100*0.54=54%

r_{sub,t}=100*(1−800/1300)=38%

and the total diesel substitution is

r_{sub}=100−(100−54)*(100−38)/100=71% (7)

The BFICU dynamically sets a target diesel substitution ratio based upon, for example, the continuous or repeated measurements of the instantaneous engine output power, the torque, and the intake manifold air pressure and exhaust oxygen as determined by the engine ECU and is reflected in the engine ECU signals to the diesel injector and the IPR valve. The BFICU computed target substitution ratio is reduced or increased based upon the OEM's fuel algorithms for a particular engine size, RPM, torque output and horsepower range and is altered to effect a desired actual substitution rate based upon the gaseous volume injection capability of a specific set or sets of gaseous injectors.

The BFICU target diesel substitution ratio is set to zero at a preselected engine speed, or other parameter. For example, when the engine RPM is below a minimum value, for example of 1000 RPM, or above a maximum value, for example, of approximately 2200 RPM, the diesel substitution is set to zero. The gaseous diesel substitution occurs only when the engine speed is within these preselected set speeds.

The hydraulic fuel pressure modification and the diesel fuel injection duration modification are adjusted continuously to track the target substitution ratio. The BFICU increases the diesel substitution if the actual substitution is below the target value and there is time available during the intake cycle to increase the gaseous fuel injection. The BFICU decreases the diesel substitution if the actual substitution ratio is above the target value.

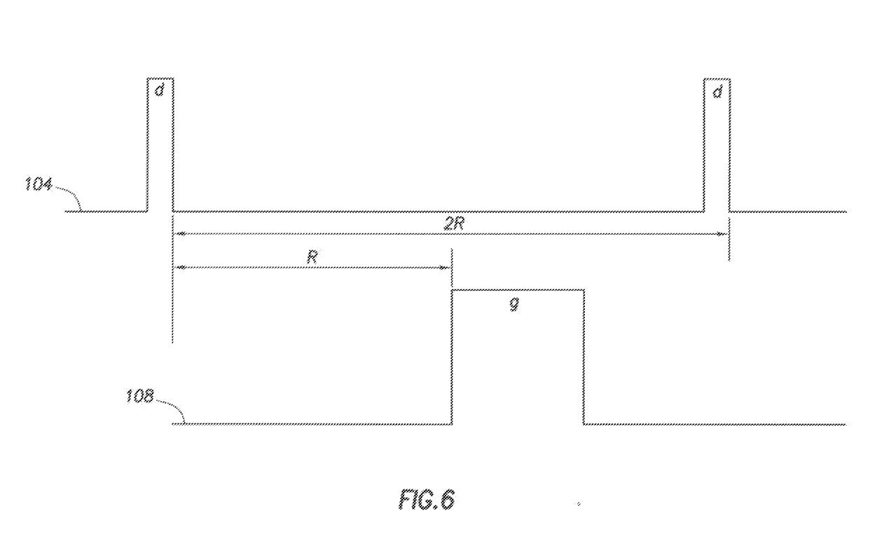

In an exemplary embodiment, the gaseous fuel injection timing is calculated by the BFICU from the end of the diesel injection and the engine RPM, both of which are derived from the ECU diesel injection control signal. The gaseous fuel injection starting time is retarded from the end-of-diesel injection time by one complete engine revolution R as shown in FIG. 6. The diesel fuel injection “d” and gaseous fuel injection “g” are shown with the gaseous injection start delayed a duration R equal to one full engine revolution. The timing between diesel injection pulses is 2R or twice the engine revolution time.

The amount of gaseous fuel to be injected to substitute for the amount of diesel fuel injection is controlled through the duration of the gaseous fuel injection t_{ng}.

t_{ng}=(r_{sub}/100)*t_{ecu}*c_{d2n} (8)

where c_{d2n} is a diesel-to gaseous fuel conversion factor that is dependent upon the characteristics of the diesel injectors, the characteristics of the gaseous fuel injectors, the hydraulic pressure of the diesel fuel injection, and the gaseous fuel pressure.

c_{d2n}=c_{d2n,r}*icp/icpᵣ (9)

where icpᵣ is the reference diesel fuel injection hydraulic pressure, c_{d2n,r} is the diesel-to gaseous fuel conversion factor at the reference hydraulic pressure.

The gaseous fuel injection duration t_{ng} is limited to no longer than the duration of the in-take stroke, which is approximately half an engine revolution. The diesel energy reduction parameters (the hydraulic pressure scaling and the diesel injection time reduction) are therefore set so that the diesel fuel energy removed does not exceed the maximum time of gaseous fuel energy injection (maximum gaseous energy) or that the gaseous fuel energy injected does not exceeded the diesel fuel energy removed.

The above description and formulae are exemplary in nature. Other formulae can be utilized as will be recognized by those of skill in the art.

In another embodiment of the current invention, the system is designed for use on a common rail diesel system. The Common Rail Diesel Fuel system is a very popular fuel system in use on several well known engine brands. The system is characterized by a high pressure fuel rail or gallery common to all the diesel injectors installed on the engine. The high pressure fuel is injected directly into the engine cylinder combustion chamber by an electrical pulse sent by the engine ECU to the injector open coil. The electrical pulse holds the injector in the open position for some specified duration of time predetermined by the OEM fuel table (algorithm) down loaded into the engine ECU. This type system is capable of multiple injections per cylinder combustion phase.

To stop the fuel injection from occurring, the engine ECU pulse is stopped and the injector plunger closes by force of a spring. Thus, unlike the HUEI system where the BFICU collects various data and modifies signals for several system components, the BFICU in a common rail system needs only to modify the duration of the engine ECU injection pulse to vary the energy injected into the engine cylinder.

The BFICU extracts the injection energy data in the same fashion as described for the HUEI fuel system except for process of the hydraulic and fuel pressure signals. Diesel fuel substitution with the gaseous fuel is accomplished in the same manner as the HUEI system with the exception of fuel pressure monitoring. Since fuel pressure is constant, only the duration of the diesel injection determines the energy value of the fuel entering the combustion chamber.

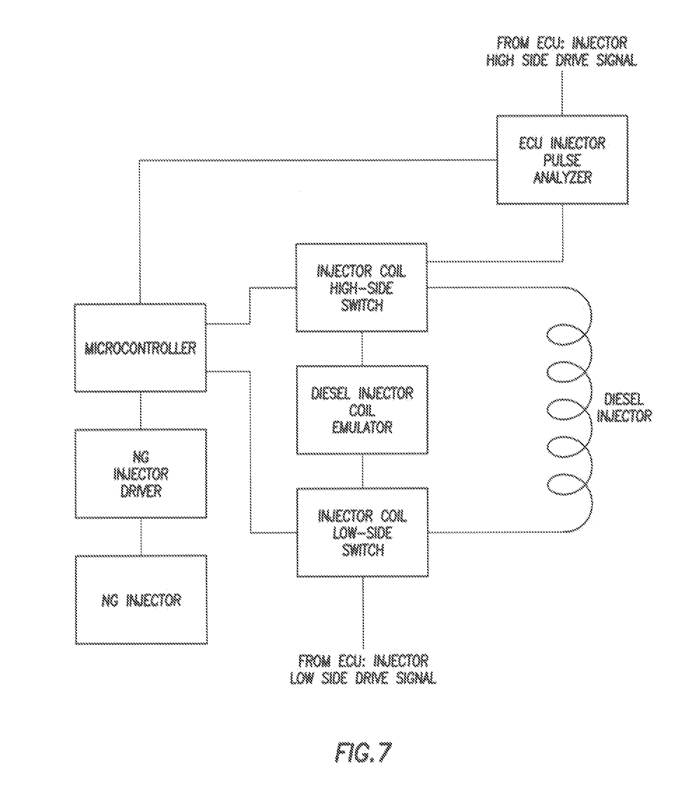

FIG. 7 shows a circuit diagram for use of BFICU components and operation for the common rail fuel system.

In FIG. 7, the BFICU injector pulse analyzer module detects the start and the end of the diesel injection pulse from the engine ECU by monitoring the current flowing through the injector coil. This information is sent to the BFICU microcontroller. The BFICU microcontroller determines the timing and the rate of the diesel injection. To substitute the diesel fuel with the gaseous fuel, the BFICU microcontroller cuts off the diesel injector pulse to shorten the diesel injection time. The BFICU micro controller substitutes the diesel fuel injection volume removed with an amount of gaseous fuel injection equivalent in energy content.

To make this process transparent to the engine ECU, the BFICU switches the engine ECU injector drive signal to a dummy coil emulating the cylinder injector coil when turning off the injector coil (injector coil high-side switch and the injector low-side switch).

The amount of diesel substitution formula is:

r_{sub}=(1−t_{targ}/t_{ecu})*100(%) (10)

where t_{ecu} is the unmodified diesel injection time from the ECU. t_{targ} is the actual diesel injection time after the reduction.

The BFICU dynamically sets a target diesel substitution ratio based upon the continuous measurements of the instantaneous engine output power, the torque, and the intake manifold air pressure and exhaust oxygen as determined by the engine ECU and is reflected in the engine ECU signals to the diesel injector. The BFICU computed target substitution ratio is reduced or increased based entirely upon the OEM's fuel algorithms for a particular engine size, RPM, torque output and horsepower range and is altered to effect a desired actual substitution rate based upon the gaseous volume injection capability of a specific set or sets of gaseous injectors.

The BFICU target diesel substitution ratio is set to zero when the engine RPM is below a minimum value of approximately 1000 RPM or above a maximum value of approximately 2200 RPM, in a preferred embodiment, and as described above. The gaseous diesel substitution occurs only when the engine speed is within these preselected set speeds.

The diesel fuel injection duration modification is adjusted continuously to track the target substitution ratio. The BFICU increases the diesel substitution if the actual substitution is below the target value and there is time available during the intake cycle to increase the gaseous fuel injection. (see the next section for details on the last point). The BFICU decreases the diesel substitution if the actual substitution ratio is above the target value.

The amount of gaseous fuel energy to be injected to substitute for the amount of diesel fuel energy reduction is controlled through the duration of the gaseous injection t_{ng}.

t_{ng}=(r_{sub}/100)*t_{ecu}*c_{d2n} (11)

where c_{d2n} is a diesel-to gaseous fuel conversion factor that is dependent upon the characteristics of the diesel injectors, the characteristics of the gaseous fuel injectors, the diesel fuel pressure, and the gaseous fuel pressure.

The gaseous fuel injection duration t_{ng} is limited to no longer than the duration of the in-take stroke, which is approximately half an engine revolution. The diesel energy reduction parameter (the diesel injection time reduction) is therefore set so that the diesel fuel energy removed does not exceed the maximum time of gaseous fuel energy injection (maximum gaseous energy) or that the gaseous fuel energy injected does not exceeded the diesel fuel energy removed.

Presented herein is a tandem fuel injector controller system for converting diesel engines to diesel- gaseous blended fuel engine. The blended fuel injector controller is inserted between the existing diesel engine ECU and the diesel and gaseous fuel injectors. The blended fuel injector controller takes the ECU fuel injector drive signals as input and generates the fuel injector drive signals to the diesel and the gaseous fuel injectors. The blended fuel injector controller continuously adjusts the ratio of the gaseous fuel to the diesel fuel based upon the engine speed, output power, torque, ambient air pressure, and the required fuel injection rate. The blended fuel injector controller employs an adaptive gaseous fuel injection timing adjustment process in which the offset of the gaseous fuel injection start time from that of the diesel fuel injection start time is adjusted continuously based upon the instantaneous engine speed (rpm). The engine speed is determined from the most recent diesel fuel injector pulse from the ECU across all cylinders. The blended fuel injector control device adapts to a variety of diesel engines without the incorporation of specific electronic protocols. The blended fuel injector control device allows the complete function of the OEM ECU on-board diagnostic functions. The blended fuel injector control device negates the use of additional or duplicated sensory devices. The blended fuel injection control device, with its adaptive timing and signal analysis, can be used on diesel engines with multiple cylinders that have a primitive electronic control system. Only an injection signal is required for the device to function. The blended fuel injector control device can turn itself off and allow uninhibited 100% diesel operation if the gaseous tanks become empty or if there is a fault in the system. The blended fuel device can perform self-diagnostics and will display a fault code when improper operation is detected. A particular fault code will also indicate a fault in the OEM injection system should a malfunction in the OEM system cause the Blended fuel injection device to turn itself off. The blended fuel injection control device will effectively reduce harmful exhaust emissions of older engines by allowing the engine to operate at or near Stochiometeric combustion conditions through the complete power curve. A blended fuel injector control device is presented for diesel fuel injection systems, such as HEUI, that involve the variation of both the diesel injection duration and the fuel pressure in controlling the fuel delivery rate, where a scaling function is inserted between the ECU fuel pressure control signal and the fuel pressure control valve to modify the fuel pressure in order to reduce the fuel delivery rate and compensating with natural gas. To make this process transparent to the ECU, the fuel pressure sensor is intercepted and modified in reverse proportion to the fuel pressure reduction. A blended fuel injector control device for the common rail type systems is presented that controls the diesel fuel delivery through a single injector coil, an injector coil emulator is used to emulate the injector when the ECU injector drive pulse is reduced. This makes the pulse width modification transparent to the ECU. An adaptive blended fuel injection system is presented that can be adjusted through substitution formula inputs for various energy density gaseous fuels such as hydrogen and propane. An adaptive blended fuel injection system is presented that can cross manufacturers or brands of engines which employ similar fuel systems that are rated for various horsepower and torque levels and various applications including constant speed applications.

Calibration is performed on the device or system once it is installed. During calibration, the engine is run at a selected speed or rpm, such as at 1500 rpm, with only diesel fuel supplied to the engine cylinders. The diesel intake can be measured for reference. The BFICU is then activated and a blend of diesel and gaseous fuel is supplied to the engine according to the above description. The addition of gaseous fuel will effect the engine speed, typically reducing the engine speed. The change in engine speed can be measured if desired. The BFICU is then programmed to alter the diesel-gaseous fuel blend until the engine speed returns to an acceptable speed, preferably the selected speed used at the initiation of calibration.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a to b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A method of converting a diesel fueled engine to a blended-fuel engine capable of operating on blended gaseous fuel and diesel fuel, the diesel fueled engine having a plurality of cylinders, a plurality of diesel fuel injectors for injecting diesel fuel into the cylinders, and an Engine Control Unit for controlling at least the operation of the diesel injectors by sending diesel fuel injector control signals to the diesel fuel injectors, the method comprising the steps of:
positioning a modified intake manifold adjacent the plurality of cylinders, the modified intake manifold for feeding fuel to the plurality of cylinders;
positioning a plurality of diesel fuel injectors in the modified intake manifold, the plurality of diesel fuel injectors for injecting diesel fuel into the plurality of cylinders;
positioning a plurality of gaseous fuel injectors in the modified intake manifold, the plurality of gaseous fuel injectors for injecting gaseous fuel into the plurality of cylinders;
positioning a Blended Fuel Injector Control Unit between the Engine Control Unit and the plurality of diesel and gaseous fuel injectors, the Blended Fuel Injector Control Unit for receiving Engine Control Unit diesel injector control signals from the Engine Control Unit and for sending BFICU control signals to the diesel fuel injectors and gaseous fuel injectors.

2. A method as in claim 1, further comprising the step of: installing a gaseous fuel tank in fluid communication with the gaseous fuel injectors.

3. A method as in claim 2, further comprising the step of: installing a gaseous fuel gauge for indicating the gaseous fuel level in the gaseous fuel tank.

4. A method as in claim 1, wherein the Blended Fuel Injector Control Unit has a plurality of diesel fuel injector control driver outputs and a plurality of gaseous fuel injector driver outputs, and further comprising the step of: connecting the plurality of diesel fuel injectors to the plurality of diesel fuel injector driver outputs and connecting the plurality of gaseous fuel injectors to the plurality of gaseous fuel injector driver outputs.

5. A method as in claim 1, further comprising the step of: installing each diesel injector to inject directly into a combustion chamber of a cylinder.

6. A method as in claim 5, further comprising the step of: installing each gaseous fuel injector to inject into an intake valve port of a cylinder.

7. A method as in claim 1, wherein the Blended Fuel Injector Control Unit calculates a desired gaseous fuel injection timing and duration based, at least in part, on received Engine Control Unit diesel injector control signals.

8. A method as in claim 7, wherein the Blended Fuel Injector Control Unit calculates a desired diesel fuel injection timing and duration based, at least in part, on received Engine Control Unit diesel injector control signals.

9. A method as in claim 1, wherein the Blended Fuel Injector Control Unit calculates a desired fuel proportion of diesel fuel and gaseous fuel to be injected, and wherein the combined energy per injection of the proportioned diesel and gaseous fuels is approximately equal to the designed engine energy per injection.

10. A method as in claim 1, wherein the Engine Control Unit diesel injector control signals received by the Blended Fuel Injector Control Unit include diesel fuel injection timing and duration data, and wherein the Blended Fuel Injector Control Unit calculates an engine speed.

11. A method as in claim 1, wherein the Blended Fuel Injector Control Unit is operable to vary the proportion of diesel fuel and gaseous fuel injected into the cylinders, from one injection cycle to another injection cycle, by varying the duration of diesel injection and the duration of gaseous fuel injection.

12. A method as in claim 11, wherein the Blended Fuel Injector Control Unit is operable to inject a relatively higher proportion of diesel fuel in an injection cycle where the engine speed is relatively high and the desired energy injection rate is relatively high.

13. A method as in claim 11, wherein the Blended Fuel Injector Control Unit is operable to inject a relatively higher proportion of diesel fuel in an injection cycle where the engine speed is relatively low and the desired energy injection rate is relatively high.

14. A method as in claim 11, wherein the Blended Fuel Injector Control Unit is operable to inject a relatively higher proportion of gaseous fuel in an injection cycle where the desired energy injection rate is relatively low.

15. A method as in claim 11, wherein the Blended Fuel Injector Control Unit is operable to inject only diesel fuel in an injection cycle where the engine speed is above a preselected amount.

16. A method as in claim 11, wherein the Blended Fuel Injector Control Unit is operable to vary the proportion of diesel fuel and gaseous fuel injected into the cylinders, from one injection cycle to another injection cycle, by varying the pressure of the diesel fuel entering the diesel fuel injector.

17. A method as in claim 16, further comprising the step of: connecting an injection pressure relief valve and an injector control pressure sensor to the Blended Fuel Injector Control Unit.

18. A method as in claim 11, wherein the Blended Fuel Injector Control Unit is transparent to the Engine Control Unit.

19. A method as in claim 11, wherein the Blended Fuel Injector Control Unit is operable to control the timing and duration of fuel injection of the diesel fuel injectors and the gaseous fuel injectors such that gaseous fuel is injected into a cylinder prior to injection of diesel fuel.

20. A method as in claim 1, further comprising the step of: calibrating the Blended Fuel Injector Control Unit by operating the engine at a selected initial speed, measuring the diesel fuel intake at that speed, then utilizing the Blended Fuel Injector Control Unit to inject a proportion of diesel fuel and gaseous fuel to the cylinders, then modifying the proportion such that the engine returns to approximately the initial speed.
